(19) United States
(12) Patent Application Publication
(10) Pub. No.: US 2013/0151205 A1
(43) Pub. Date: Jun. 13, 2013

(54) DESIGN ASSISTING APPARATUS, METHOD FOR ASSISTING DESIGN, AND RECORDING MEDIUM FOR DESIGN ASSISTING PROGRAM

(71) Applicant: Fujitsu Limited, Kawasaki (JP)

(72) Inventors: Yoshikazu ICHIKAWA, Yokohama (JP); Kazuhiko HAMAZOE, Kawasaki (JP); Yukari SATO, Inagi (JP)

(73) Assignee: FUJITSU LIMITED, Kawasaki (JP)

(21) Appl. No.: 13/668,572

(22) Filed: Nov. 5, 2012

(30) Foreign Application Priority Data
Dec. 9, 2011 (JP) 2011-270230

(51) Int. Cl. G06F 17/50

(52) U.S. Cl. 703/1

(57) ABSTRACT

A design assisting apparatus includes a processor and a memory coupled to the processor. The processor executes a process that includes storing a number of restrictions that restrict degrees of freedom in a translational direction and a rotational direction of each of three dimensional directions at an assembled place in an assembled state of a component that is part of a product to be designed, and deciding, by using the number of the restrictions stored in the storing, whether or not to apply a geometrical tolerance to the dimension at the assembled place of the component.

### CROSS-REFERENCE TO RELATED APPLICATION

This application is based upon and claims the benefit of priority of the prior Japanese Patent Application No. 2011-270230, filed on Dec. 9, 2011, the entire contents of which are incorporated herein by reference.

### FIELD

The embodiments discussed herein are related to a design assisting apparatus, a method for assisting design, and a recording medium for a design assisting program.

### BACKGROUND

In a tolerance analysis technology known in the computer-aided design (CAD) field, dimensional tolerances and geometrical tolerances are set for a plurality of components to be assembled and variations in dimensions and shapes after the assembling are calculated. When tolerance analysis is executed, shapes, orientations, and positions can be restricted for points, lines, planes, and other geometrical features.

When a designer determines a portion of a component at which to set a geometrical tolerance, there is a possible method in which the designer sets a geometrical tolerance at a portion that the designer has determined according to, for example, his or her experience and confirms the validity of the determination through repeated analysis.

Since the determination as to whether to set a geometrical tolerance involves experience, however, it is not easy to determine a portion to which a geometrical tolerance is to be applied.

Japanese Laid-open Patent Publication No. 2006-277305 is an example of related art.

### SUMMARY

According to an aspect of the invention, a design assisting apparatus includes a processor and a memory coupled to the processor. The processor executes a process that includes storing a number of restrictions that restrict degrees of freedom in a translational direction and a rotational direction of each of three dimensional directions at an assembled place in an assembled state of a component that is part of a product to be designed, and deciding, by using the number of the restrictions stored in the storing, whether or not to apply a geometrical tolerance to the dimension at the assembled place of the component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a design assisting apparatus in a first embodiment;

FIG. 2 illustrates the hardware structure of a design assisting apparatus in a second embodiment;

FIG. 3 is a functional block diagram of the design assisting apparatus in the second embodiment;

FIG. 4 illustrates an example of a three-dimensional model;

FIGS. 5A and 5B each illustrate an assembly definition and object information;

FIGS. 6A and 6B each also illustrate an assembly definition and object information;

FIG. 7 illustrates a component tree;

FIG. 8 illustrates an example of an importance ranking table;

FIG. 9 illustrates processing executed by a geometrical tolerance application determining unit;

FIG. 10 illustrates an example of a geometrical tolerance application deciding table;

FIG. 11 illustrates an example of a geometrical tolerance table;

FIG. 12 illustrates what type of geometrical tolerance is applied;

FIG. 13 illustrates an example of a component to which geometrical tolerances are applied;

FIG. 14 is a method illustrating whole processing executed by the design assisting apparatus;

FIG. 15 is a method illustrating processing executed by a tolerance analyzing unit;

FIG. 16 is a method illustrating importance determining processing;

FIG. 17 is a method illustrating geometrical tolerance application determining processing;

FIG. 18 is a method illustrating geometrical tolerance setting processing;

FIG. 19 illustrates an application example;

FIG. 20 illustrates an example of a three-dimensional model in a third embodiment;

FIG. 21 illustrates object information at assembly definition places in the third embodiment;

FIG. 22 illustrates a component tree in the third embodiment; and

FIGS. 23A to 23C illustrate processing results obtained from the geometrical tolerance application determining unit in the third embodiment.

### DESCRIPTION OF EMBODIMENTS

A design assisting apparatus in embodiments will be described in detail with reference to the drawings.

### First Embodiment

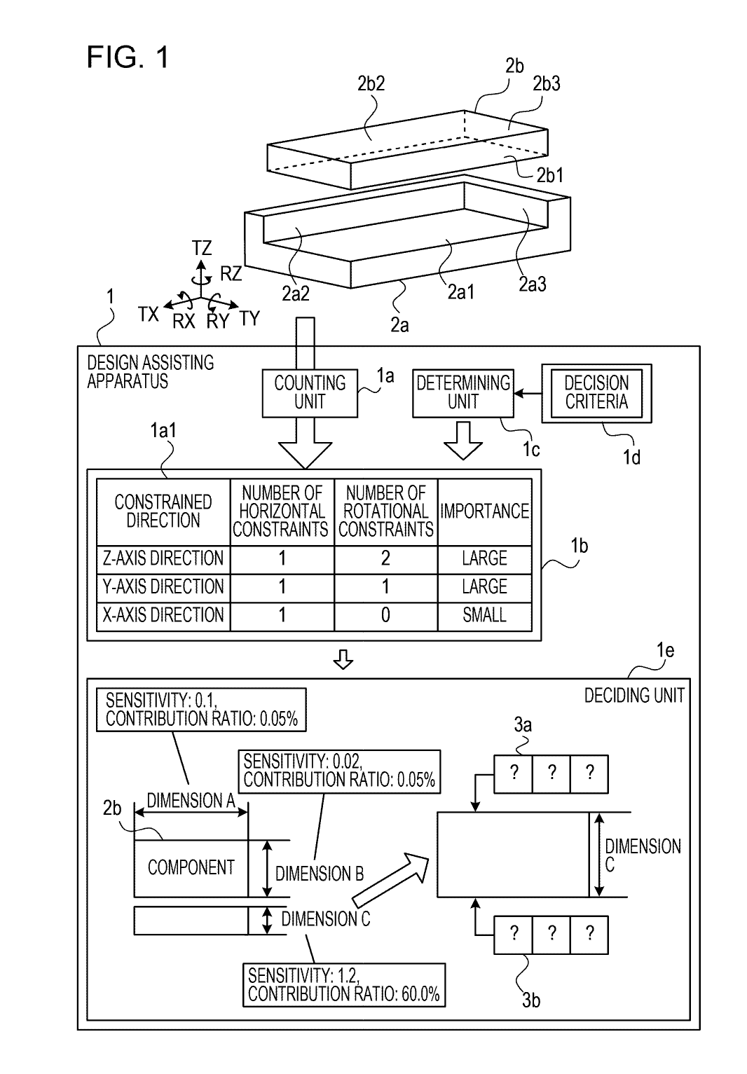

FIG. 1 illustrates a design assisting apparatus in a first embodiment.

The design assisting apparatus (computer) 1 in the first embodiment has a counting unit 1a, a storage unit 1b, a determining unit 1c, a storage unit 1d, and a deciding unit 1e.

The counting unit 1a, determining unit 1c, and deciding unit 1e can be implemented by a central processing unit (CPU) included in the design assisting apparatus 1. The storage units 1b and 1d can be implemented by a random access memory (RAM) included in the design assisting apparatus 1 or a data storage area in a hard disk drive (HDD) or the like.

The counting unit 1a counts the number of constraints that restrict degrees of freedom in directions translational to the three dimensional directions and in rotational directions around the three dimensional directions when components 2a and 2b are in an assembled state, the components 2a and 2b being part of a three-dimensional model, which is a design target, created by a three-dimensional CAD application.

The components 2a and 2b are assembled together at three places at which a portion 2a1 of the component 2a and a portion 2b1 of the component 2b are assembled, a portion 2a2 of the component 2a and a portion 2b2 of the component 2b are assembled, and a portion 2a3 of the component 2a and a portion 2b3 of the component 2b are assembled.

To count the number of constraints that restrict degrees of freedom in the translational directions and rotational directions at the assembled places, the counting unit 1a has system coordinates, illustrated in FIG. 1, in which three normal directions are orthogonal to one another in the X-axis direction, Y-axis direction, and Z-axis direction. Degrees of freedom in translational movement and degrees of freedom in rotational movement between two components are defined in the system coordinates. In FIG. 1, degrees of freedom in translational movement in the X-axis direction are denoted T(Translation)X, degrees of freedom in translational movement in the Y-axis direction are denoted TY, degrees of freedom in translational movement in the Z-axis direction are denoted TZ, degrees of freedom in rotational movement around the X-axis direction are denoted R(Rotation)X, degrees of freedom in rotational movement around the Y-axis direction are denoted RY, and degrees of freedom in rotational movement around the Z-axis direction are denoted RZ. Therefore, there are degrees of freedom in a total of six directions in translational directions and rotational directions. The counting unit 1a counts the number of normal directions of the three normal directions and creates extracted information 1a1 in which the number of constraints that restrict degrees of freedom in the translational direction and in the rotational direction in each of the counted normal directions has been extracted. The counting unit is then stores the extracted information 1a1 in the storage unit 1b. In this embodiment, the normal direction in which the portion 2a1 and portion 2b1 are assembled together is translational to the Z axis, the normal direction in which the portion 2a2 and portion 2b2 are assembled together is translational to the Y axis, and the normal direction in which the portion 2a3 and portion 2b3 are assembled together is translational to the X axis.

The counting unit is also executes tolerance analysis calculation. The tolerance analysis calculation is used to set dimensional tolerances and geometrical tolerances for a plurality of components to be assembled together and calculate variations in dimensions and shapes after the assembly. Specifically, the counting unit 1a executes the tolerance analysis calculation to calculate sensitivity (lever ratio) and a contribution ratio for a portion at an assembly definition place. The sensitivity is an index indicating a dimensional value that largely affects assembly precision (variations). The contribution ratio is an index indicating a tolerance value that largely affects assembly precision (variations).

The determining unit 1c determines importance of portions at assembly definition places of the component 2a and component 2b, the importance being relative among the components, from the number of constraints that restrict degrees of freedom in the directions translational to the normal directions and the number of constraints that restrict degrees of freedom in the rotational directions around the counted normal directions, these numbers being counted by the counting unit 1a. The storage unit 1d pre-stores decision criteria used to determine importance. Examples of decision criteria are described below.

If at least one of RX, RY, and RZ is constrained, the determining unit 1c determines the importance of the portion at the assembly definition place to be large. This is because if rotational movement is constrained at one or more places, it is affected by an angular component.

If at least two of TX, TY, and TZ are constrained in the same direction, the determining unit 1c determines the importance of the portion at the assembly definition place to be medium. This is because if there are two or more constraints in the same direction, the translational movement is affected by the distance between separate locations.

For an assembly definition place other than assembly definition places the importance of which is large or medium, the determining unit 1c determines the importance of the portion at the assembly definition place to be small.

The deciding unit 1e uses the importance determined by the determining unit 1c and to the sensitivity and contribution ratio calculated by the counting unit 1a to decide whether to apply a geometrical tolerance to the portion at each assembly definition place of the components 2a and component 2b. If the importance is large and the sensitivity is 1.0 or greater, the deciding unit 1e decides to apply a geometrical tolerance regardless of the value of the contribution ratio. If the sensitivity is smaller than 0.5, the deciding unit 1e decides not to apply a geometrical tolerance regardless of the value of the importance. FIG. 1 illustrates a case in which the decision criteria are applied to dimensions A, B, and C of the component 2b in the three normal directions. Since the dimension A translational to the X-axis direction and the dimension B translational to the Y-axis each have a sensitivity of smaller than 0.5, the deciding unit 1e decides not to apply a geometrical tolerance to the dimensions A and B. Since the importance of the dimension C translational to the Z-axis direction is large and its sensitivity is 1.0 or greater, however, the deciding unit 1e decides to apply a geometrical tolerance to the dimensions C of the component 2b.

The deciding unit 1e sets tolerance entry fields 3a and 3b for the dimension C for which application of a geometrical tolerance has been decided. Types of geometrical tolerances and the method of determining their values will be described in detail in a second embodiment.

With the design assisting apparatus 1, to indicate a place to which to apply a geometrical tolerance, the number of constraints that restrict degrees of freedom in directions translational to the three dimensional directions and in rotational directions around the three dimensional directions at an assembled place of components are regarded as a degree of an effect on a dimensional tolerance between the components and are used as an aid to decide whether to apply the geometrical tolerance. Thus, it is possible, for example, to suppress a place to which to apply a geometrical tolerance from being overlooked, enabling design quality to be improved. In addition, processing time can be made shorter than when analysis is repeatedly executed.

In a second embodiment, the disclosed design assisting apparatus will be specifically described.

### Second Embodiment

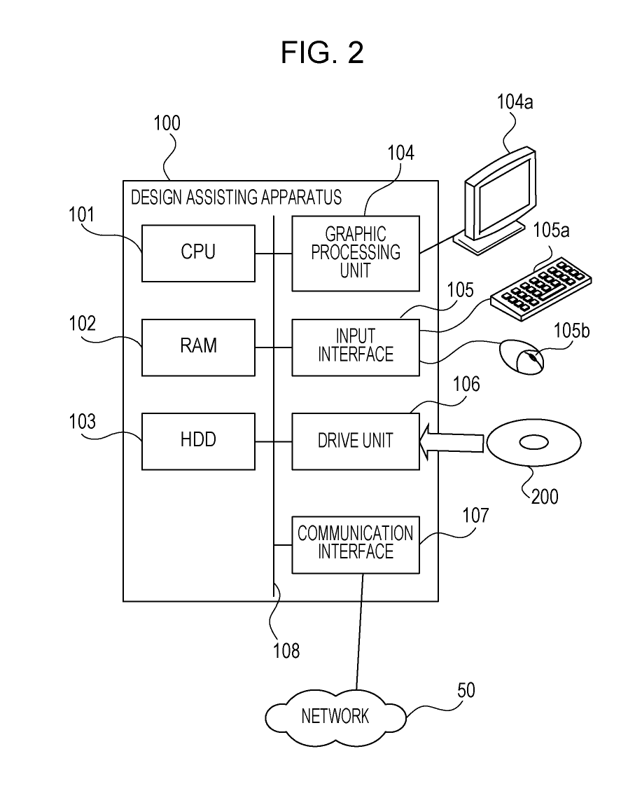

FIG. 2 illustrates the hardware structure of a design assisting apparatus in the second embodiment.

The whole of the design assisting apparatus 100 is controlled by a CPU 101. A RAM 102 and a plurality of peripheral units are connected to the CPU 101 through a bus 108.

The RAM 102 is used as a main storage unit of the design assisting apparatus 100. The RAM 102 temporarily stores at least part of an operating system (OS) and application programs executed by the CPU 101. The RAM 102 also stores various types of data used by the CPU 101 during processing.

A hard disk drive 103, a graphic processing unit 104, an input interface 105, a drive unit 106, and a communication interface 107 are connected to the bus 108.

The hard disk drive 103 magnetically writes data onto and reads data from a built-in disk. The hard disk drive 103 is used as a secondary storage unit of the design assisting apparatus 100. The hard disk drive 103 stores the OS, application programs, and various types of data. A semiconductor storage unit such as a flash memory can also be used as the secondary storage unit.

A monitor 104a is connected to the graphic processing unit 104. The graphic processing unit 104 displays images on the screen of the monitor 104a in response to commands from the CPU 101. Examples of the monitor 104a include a display unit that uses a cathode ray tube (CRT) and a liquid crystal display unit.

A keyboard 105a and a mouse 105b are connected to the input interface 105. The input interface 105 receives signals from the keyboard 105a and mouse 105b and transmits the received signals to the CPU 101. The mouse 105b is an example of a pointing device; another type of pointing device can also be used. Examples of other types of pointing devices include a touch-panel tablet, a touch pad, and a trackball.

The drive unit 106 reads data from an optical disk on which data has been stored so that it can be read by reflected light or from a portable storage unit such as a universal serial bus (USB) memory. When the drive unit 106 is an optical drive unit, for example, laser beams are used to read data from an optical disk 200. Examples of the optical disk 200 include a Blu-ray®, a digital versatile disc (DVD), a DVD-RAM, a compact disc read-only memory (CD-ROM), a compact-disc recordable (CD-R), and a compact-disc rewritable (CD-RW).

The communication interface 107 is connected to a network 50. The communication interface 107 transmits and receives data to and from another computer or a communication unit through the network 50.

Processing functions in this embodiment can be implemented by the hardware structure described above.

The design assisting apparatus 100 with the hardware structure illustrated in FIG. 2 has functions as described below.

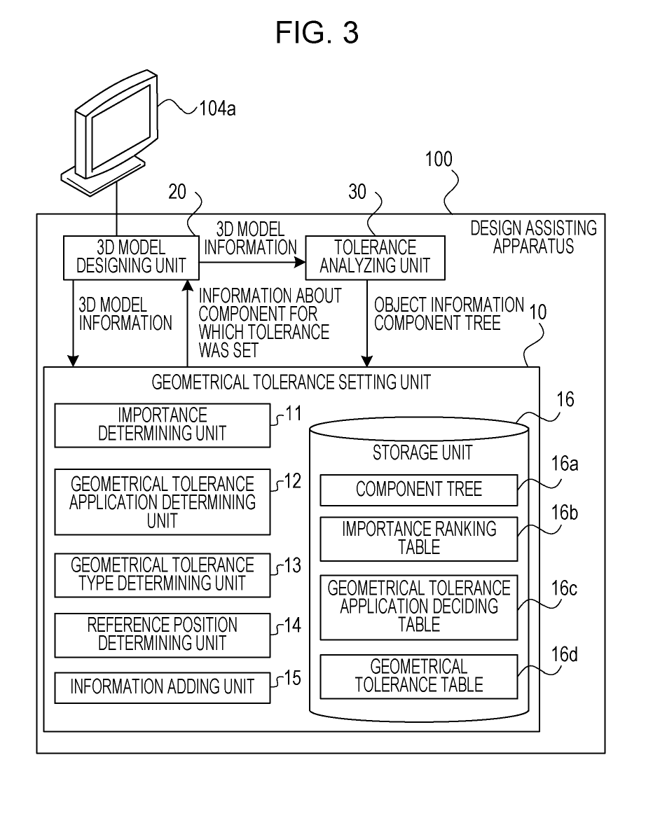

FIG. 3 is a functional block diagram of the design assisting apparatus 100 in the second embodiment.

The design assisting apparatus 100 includes a geometrical tolerance setting unit 10, a three-dimensional model designing unit 20, and a tolerance analyzing unit 30. The tolerance analyzing unit 30 is an example of the counting unit 1a.

The three-dimensional model designing unit 20 receives a two-dimensional model of a product to be designed and creates a three-dimensional model of the product from the received two-dimensional model. The three-dimensional model designing unit 20 transmits information about the shape, dimensions, colors, and coordinates of the created three-dimensional model to the tolerance analyzing unit 30. The three-dimensional model designing unit 20 also receives, from the geometrical tolerance setting unit 10, information about a component for which a geometrical tolerance has been set, and reflects a geometrical tolerance included in the received information into the relevant component of the three-dimensional model.

The tolerance analyzing unit 30 defines assembly definition information and degrees of freedom for each two components constituting the three-dimensional model. In the assembly definition, a component' shape to be used to assemble the component to a counterpart is defined for an assembly model formed with two or more components.

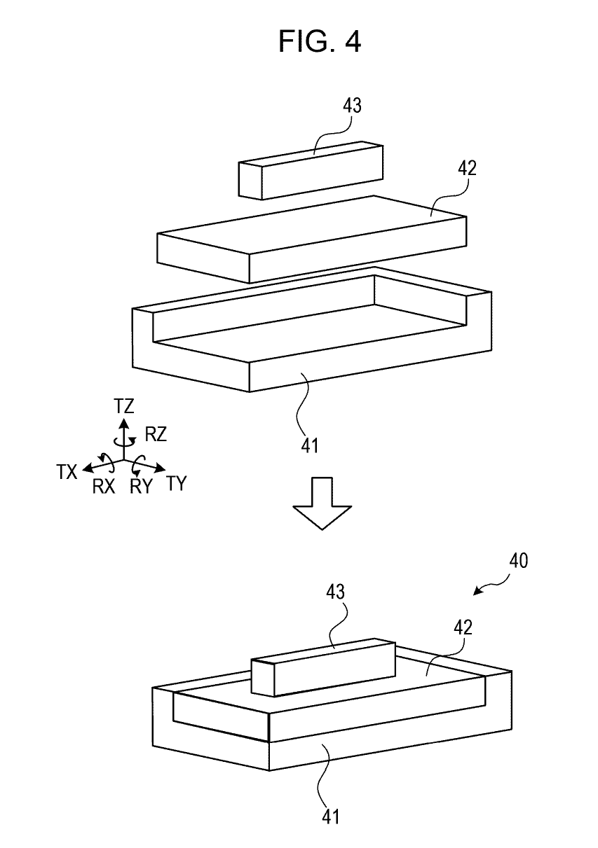

FIG. 4 illustrates an example of a three-dimensional model 40.

The three-dimensional model 40 is an example of three-dimensional models created by the three-dimensional model designing unit 20. With the three-dimensional model 40, a component 42 is assembled to a component 41. A component 43 is assembled to the component 42 in a face-to-face manner.

The tolerance analyzing unit 30 prepares system coordinates, illustrated in FIG. 4, in which three normal directions are orthogonal to one another in the X-axis direction, Y-axis direction, and Z-axis direction. The tolerance analyzing unit 30 then defines degrees of freedom in translational movement and degrees of freedom in rotational movement between two components in the system coordinates. In the descriptions below, degrees of freedom in translational movement in the X-axis direction are denoted TX, degrees of freedom in translational movement in the Y-axis direction are denoted TY, degrees of freedom in translational movement in the Z-axis direction are denoted TZ, degrees of freedom in rotational movement around the X-axis direction are denoted RX, degrees of freedom in rotational movement around the Y-axis direction are denoted RY, and degrees of freedom in rotational movement around the Z-axis direction are denoted RZ. Therefore, there are degrees of freedom in a total of six directions in translational directions and rotational directions.

The tolerance analyzing unit 30 counts the number of normal directions of the three normal directions at each assembly definition place and creates object information including constraint information in which the number of degrees of freedom in translational movement in the three normal directions and the number of degrees of freedom in rotational movement around the three normal directions have been extracted. The object information is created for each plane. The object information is created for normal directions until degrees of freedom are restricted in all the six directions.

In addition to the assembly definition, the tolerance analyzing unit 30 creates a component tree, which indicates object information and states of components to be assembled.

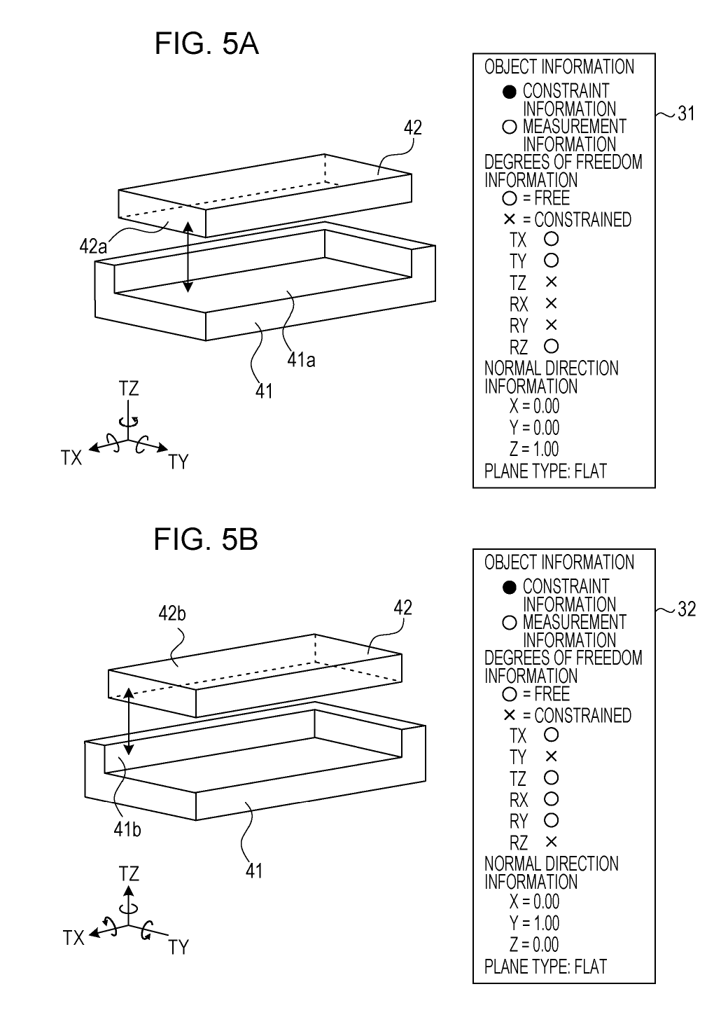

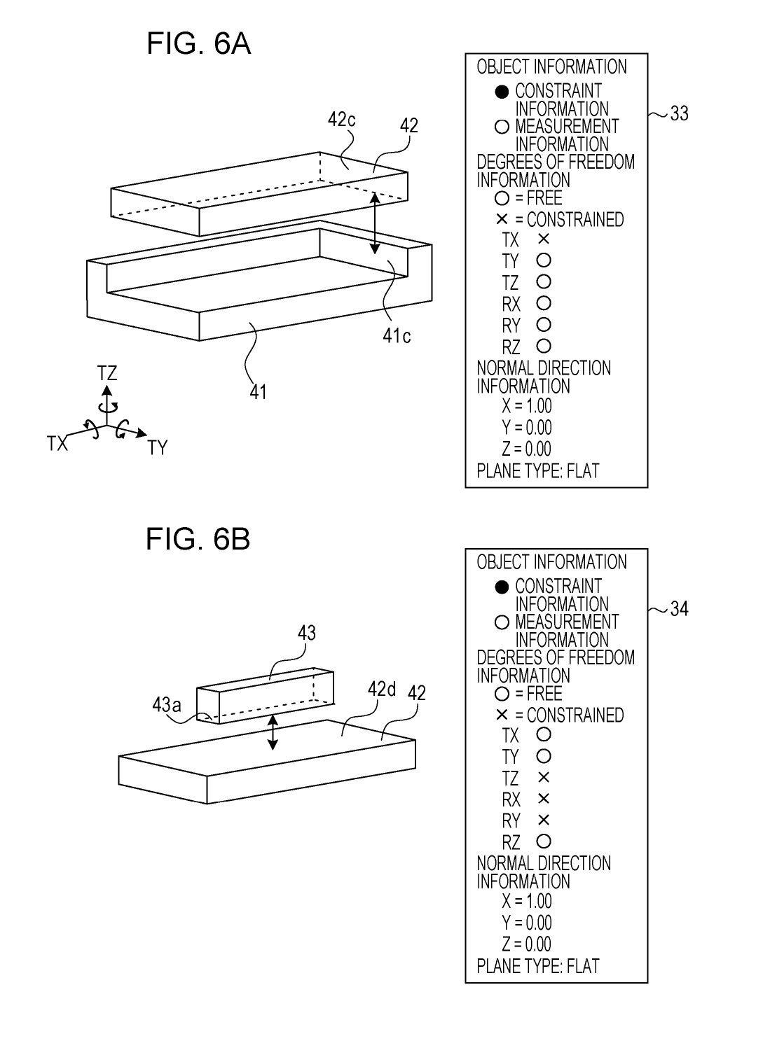

FIGS. 5A and 5B and FIGS. 6A and 6B each illustrate an assembly definition and object information.

Planes of the component 41 and component 42 are assigned reference characters so that mutually relationships are provided. For example, a plane 41a of the component 41 and a plane 42a of the component 42 indicate that they are assembled together.

FIG. 5A illustrate an assembly of the plane 41a of the component 41 and the plane 42a of the component 42, the normal direction of which is in the Z-axis direction. This assembly will be referred to below as a first assembly definition place. Object information 31, which relates to the first assembly definition place, includes constraint information indicating a constrained state, degrees of freedom information about the six directions, and normal direction information. The constraint information indicates a free state, in which translational movement and rotational movement can be freely made in each direction, or a constrained state, in which free translational movement and free rotational movement are suppressed. In FIGS. 5A and 5B, the constrained state is indicated by system coordinates and the object information 31. In the system coordinates, a direction with an arrow indicates that translational movement or rotational movement in that direction is not constrained (in the free state) and a direction without an arrow indicates that translational movement or rotational movement in that direction is constrained (in the constrained state).

For the assembly of the plane 41a of the component 41 and the plane 42a of the component 42 illustrated in FIG. 5A, the tolerance analyzing unit 30 determines that the Z-axis direction is a perpendicular direction and that TZ, RX, and RY are in the constrained state. The tolerance analyzing unit 30 also determines that there is no other definition place having information about the normal direction in the Z-axis direction.

Since the object information 31 still includes degrees of freedom in the free state (TX, TY, and RZ), the tolerance analyzing unit 30 makes an assembly definition relating to other normal directions of the component 41 and component 42.

FIG. 5B illustrates an assembly of a plane 41b of the component 41 and a plane 42b of the component 42, the normal directions of which are in the Y-axis direction. This assembly will be referred to below as a second assembly definition place. Object information 32 relates to the second assembly definition place.

The tolerance analyzing unit 30 determines that the Y-axis direction is a perpendicular direction and that TY and RZ are in the constrained state. The tolerance analyzing unit 30 also determines that there is no other definition place having information about the normal direction in the Y-axis direction.

Even if the object information 31 and object information 32 are combined, degrees of freedoms TX in the free state remain, so the tolerance analyzing unit 30 makes an assembly definition about another normal direction of the component 41 and component 42.

FIG. 6A illustrates an assembly of a plane 41c of the component 41 and a plane 42c of the component 42, the normal directions of which are in the X-axis direction. This assembly will be referred to below as a third assembly definition place. Object information 33 relates to the third assembly definition place.

The tolerance analyzing unit 30 decides that the X-axis direction is the perpendicular direction and that TX is in the constrained state. The tolerance analyzing unit 30 also determines that there is no other definition place having information about the normal direction in the X-axis direction.

FIG. 6B illustrates an assembly of a plane 42d of the component 42 and a plane 43a of the component 43. This assembly will be referred to below as a fourth assembly definition place. Object information 34 relates to the fourth assembly definition place. In this embodiment, it is assumed that the component 43 is assembled in a face-to-face manner and is fixed.

After having made assembly definitions for two or more components, the tolerance analyzing unit 30 creates a component tree 16a. The tolerance analyzing unit 30 then transmits the created component tree 16a to the geometrical tolerance setting unit 10. The geometrical tolerance setting unit 10 receives the component tree 16a and stores it in the storage unit 16.

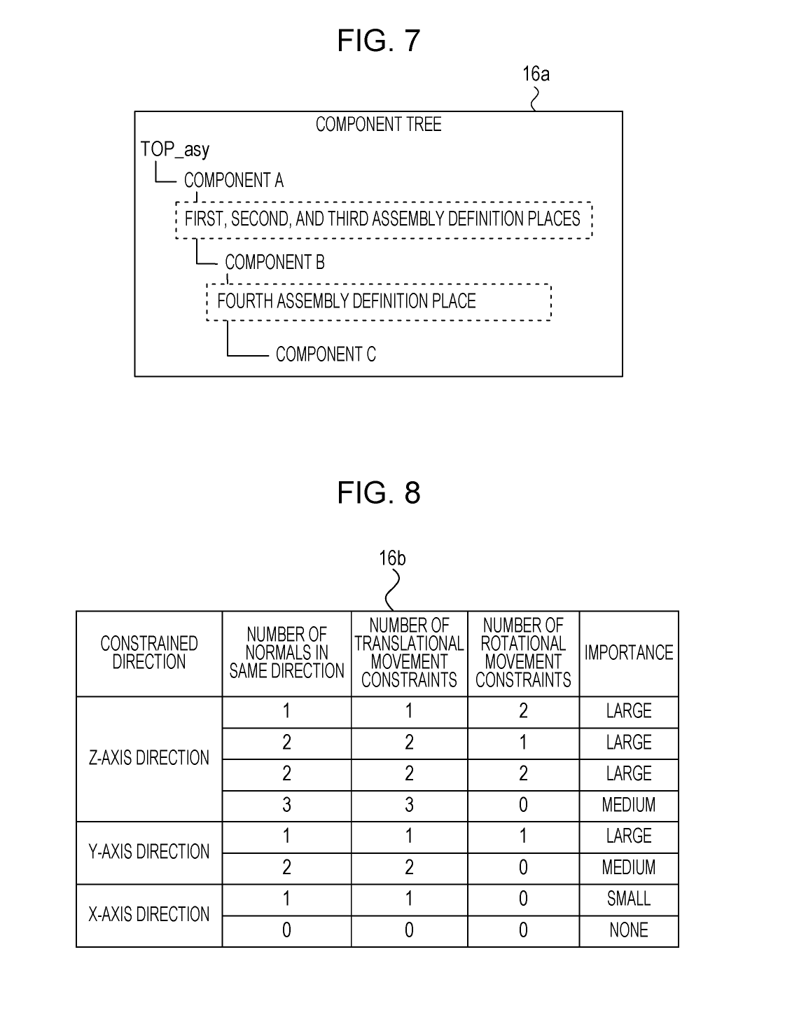

FIG. 7 illustrates the component tree 16a.

The component tree 16a includes a sequence in which assembly definitions have been made, dependence information between components, and assembly definition information between components.

For example, the component tree 16a indicates that there are three assembly definitions, which are identified by the first, second, and third assembly definition places, between the component 41 and the component 42 and that there is one assembly definition, which is identified by the fourth assembly definition place, between the component 42 and the component 43. The component tree 16a also indicates that the component 42 is subordinate to the component 41 and the component 43 is subordinate to the component 42. The component tree 16a also indicates that when the three-dimensional model 40 is created, the component 41 is assembled to the component 42, after which the component 43 is assembled.

The tolerance analyzing unit 30 executes tolerance analysis calculation to calculate sensitivity (lever ratio) and a contribution ratio for a portion at each assembly definition place. The tolerance analysis calculation method is known technology, so its detailed description will be omitted.

The geometrical tolerance setting unit 10 uses the object information items 31 to 34, the component tree 16a, the sensitivity, and the contribution ratio, which have been obtained from the tolerance analyzing unit 30 to set a geometrical tolerance in the three-dimensional model 40 created by the three-dimensional model designing unit 20.

The geometrical tolerance setting unit 10 includes an importance determining unit 11, a geometrical tolerance application determining unit 12, a geometrical tolerance type determining unit 13, a reference position determining unit 14, an information adding unit 15, and a storage unit 16. The geometrical tolerance application determining unit 12 is an example of the deciding unit.

The importance determining unit 11 uses the object information items 31 to 34 created by the tolerance analyzing unit 30 to set the number of normals in the same direction and the number of constraints that restrict degrees of freedom in the translational directions and rotational directions in relevant fields of an importance ranking table 16b. The importance determining unit 11 determines importance, according to which it is decided whether to apply a geometrical tolerance to a portion at an assembly definition place, by applying a rule given in advance to the values set in the importance ranking table 16b. This rule can be determined by the designer and can be pre-stored in the RAM 102 or hard disk drive 103.

FIG. 8 illustrates an example of the importance ranking table 16b.

The importance ranking table 16b has fields in which constrained directions, the number of normals in the same direction, the number of translational movement constraints, the number of rotational movement constraints, and importance are set. Information items placed in the horizontal direction are mutually related.

The importance ranking table 16b in FIG. 8 is only an example; information other than the object information items 31 to 34 is also included.

In the constrained direction field, the direction of an axis, by which a constrained direction is identified, is set.

In the field of the number of normals in the same direction, a value in the normal direction information extracted by the importance determining unit 11 from the object information is set.

In the field of the number of translational movement constraints, a value that identifies the number of constraints that restrict degrees of freedom TX, TY or TZ is set, the value being extracted by the importance determining unit 11 from the object information.

In the field of the number of rotational movement constraints, a value that identifies the number of constraints that restrict degrees of freedom RX, RY or RZ is set, the value being extracted by the importance determining unit 11 from the object information.

In the importance field, importance determined by the importance determining unit 11 according to the value in the field of the number of normals in the same direction, the value in the field of the number of translational movement constraints, and the value t in the field of the number of rotational movement constraints is set.

If at least one of RX, RY, and RZ is constrained, the importance determining unit 11 determines the importance of the portion at the assembly definition place to be large. This is because if rotational movement is constrained at one or more places, it is affected by an angular component.

If at least two of TX, TY, and TZ are constrained in the same direction, the importance determining unit 11 determines the importance of the portion at the assembly definition place to be medium. This is because if there are two or more constraints in the same direction, the translational movement is affected by the distance between separate locations.

The importance determining unit 11 also determines the importance of an assembly definition place other than the assembly definition places the importance of which is large or medium to be small.

The importance determining unit 11 also determines “none” for importance of an assembly definition place at which the six degrees of freedom are constrained in two axial directions (in FIG. 8, Z-axis direction and Y-axis direction) and definition does not take effect for the remaining axial direction (in FIG. 8, X-axis direction).

The geometrical tolerance application determining unit 12 decides whether to apply a geometrical tolerance to the portion at each assembly definition place at which importance has been ranked.

When deciding whether to apply a geometrical tolerance, the geometrical tolerance application determining unit 12 uses, as a decision aid, the sensitivity and contribution ratio of the shape at each assembly definition place, which represent a degree of an effect caused by error in dimensions constituting the shape.

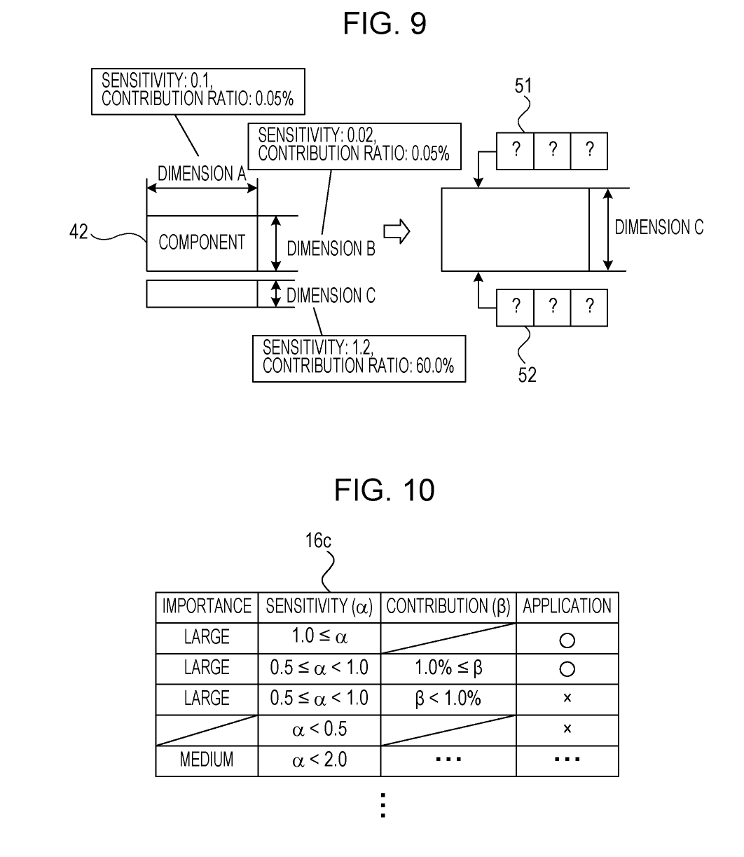

FIG. 9 illustrates processing executed by the geometrical tolerance application determining unit 12.

FIG. 9 illustrates calculation results of the sensitivity and contribution ratio for dimensions of a portion for which the tolerance analyzing unit 30 has made an assembly definition for the component 42 after the tolerance analyzing unit 30 had carried out tolerance analysis. The geometrical tolerance application determining unit 12 uses a geometrical tolerance application deciding table 16c to decide whether to apply a geometrical tolerance to each dimension.

FIG. 10 illustrates an example of the geometrical tolerance application deciding table 16c.

The geometrical tolerance application deciding table 16c has fields in which importance, sensitivity, the contribution ratio, and a decision as to whether to apply a geometrical tolerance are set. Information items placed in the horizontal direction are mutually related.

In the importance field, information that identifies ranked importance is set.

In the sensitivity field, values that classify the sensitivity are set. In the contribution ratio field, values that classify the contribution ratio are set.

In the application field, information that indicates whether to apply a geometrical tolerance is set.

A cell in which an oblique line is drawn indicates a portion that does not affect a decision as to whether to apply a geometrical tolerance. If, for example, importance is large and sensitivity is 1.0 or greater, a geometrical tolerance is applied regardless of the value of the contribution ratio. If sensitivity is smaller than 0.5, no geometrical tolerance is applied regardless of the value of the importance.

The geometrical tolerance application determining unit 12 applies the geometrical tolerance application deciding table 16c in FIG. 10 to the dimension A of the component 42 in FIG. 9, which is translational to the X-axis direction, the dimension B translational to the Y-axis direction, and the dimension C translational to the Z-axis direction. Since the sensitivity of the dimensions A and B is smaller than 0.5, the geometrical tolerance application determining unit 12 determines not to apply a geometrical tolerance to the dimensions A and B. Since the importance of the dimension C is large and its sensitivity is 1.0 or greater, however, the geometrical tolerance application determining unit 12 determines to apply a geometrical tolerance to the dimension C.

The geometrical tolerance application determining unit 12 sets tolerance entry fields 51 and 52 for the dimension C for which application of a geometrical tolerance has been determined. At this point in time, however, a dimension reference position is unknown, so a type of geometrical tolerance to be applied is not determined. Accordingly, question marks are set in the tolerance entry fields 51 and 52 (alternatively, the tolerance entry fields 51 and 52 are left blank).

For the dimension C for which the geometrical tolerance application determining unit 12 has determined to apply a geometrical tolerance, the geometrical tolerance type determining unit 13 uses a geometrical tolerance table 16d to determine a type of applicable geometrical tolerance.

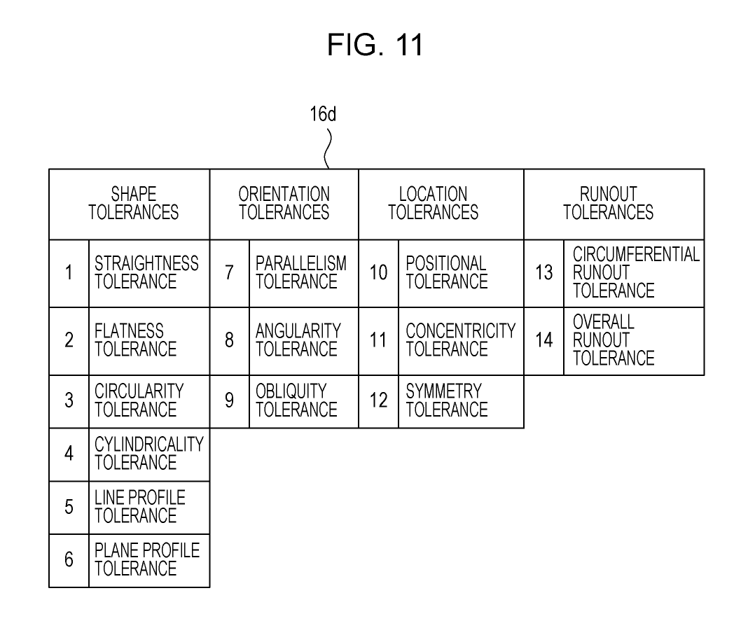

FIG. 11 illustrates an example of the geometrical tolerance table 16d.

The geometrical tolerance table 16d has fields in which shape tolerances, orientation tolerances, location tolerances, and runout tolerances are set. Specific types of tolerance are set below the header of each tolerance field. The tolerances are assigned serial numbers. The types of tolerances are based on JIS B 0021.

The geometrical tolerance type determining unit 13 uses information about the plane type in the object information to select applicable geometrical tolerances. For example, the plane type in the object information 31 is “flat”. In this case, the geometrical tolerance type determining unit 13 determines flatness tolerance, plane profile tolerance, parallelism tolerance, and the like as applicable tolerance types. If the plane type in the object information is “cylinder”, the geometrical tolerance type determining unit 13 determines circularity tolerance, cylindricality tolerance, concentricity tolerance, positional tolerance, and the like as applicable tolerance types. The designer can determine correspondence between plane types and tolerances to be applied according to the plane types in advance.

The reference position determining unit 14 uses the component tree 16a to determine the dimension reference position of the component 42. Specifically, the reference position determining unit 14 uses the component tree 16a to decide that the component 42 is subordinate to the component 41 and the component 43 is subordinate to the component 42.

Next, the reference position determining unit 14 decides, from upper and lower information items (constituting an assembly sequence) in the component tree 16a, that the definition for the component 41 of the two definition places of the component 42 is a high-end definition and the definition for the component 43 is a low-end definition. According to this decision, the reference position determining unit 14 ranks the assembly definition places of the component 42. Specifically, the reference position determining unit 14 determines the high-end definition in the ranking to be the dimension reference position of the component 42.

To set a type of geometrical tolerance, the reference position determining unit 14 applies the type of geometrical tolerance determined by the geometrical tolerance type determining unit 13 to the determined dimension reference position.

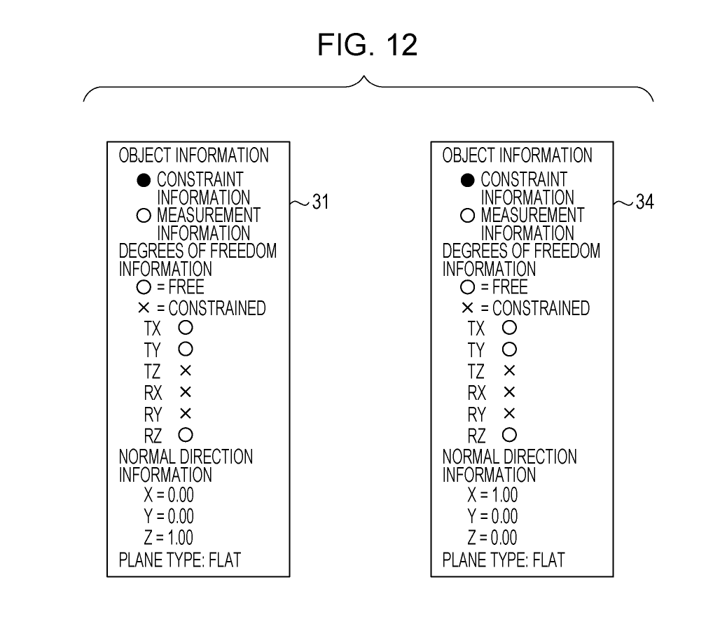

FIG. 12 illustrates what type of geometrical tolerance is applied.

The object information 31 indicates that the component 41 and component 42 are defined so that their planes are assembled to each other. Since the first assembly definition place is ranked as a high-end definition in the assembly definition, the first assembly definition place is used as the dimension reference position, so a geometrical tolerance that does not use a shape to be referenced can be applied to the first assembly definition place. Accordingly, the reference position determining unit 14 selects the flatness tolerance, which is suitable to flat shapes, from the shape tolerances determined by the geometrical tolerance type determining unit 13. As conditions under which degrees of freedom are constrained, the number of constraints that restrict degrees of freedom in translational movements in the normal directions is set to 1 and the number of constraints that restrict degrees of freedom in rotational movements around the axes orthogonal to the normals is set to 2.

The object information 34 indicates that the component 42 and component 43 are defined so that their planes are assembled to each other. Since the fourth assembly definition place is ranked as a low-end definition in the assembly definition, the reference position determining unit 14 selects the parallelism tolerance from the shape tolerances that use the first assembly definition place as a shape to be referenced. As conditions under which degrees of freedom are constrained, the number of constraints that restrict degrees of freedom in translational movements in the normal directions is set to 1 and the number of constraints that restrict degrees of freedom in rotational movements around the axes orthogonal to the normals is set to 2.

The information adding unit 15 enters the type of tolerance selected by the reference position determining unit 14 into the tolerance entry fields 51 and 52. The information adding unit 15 transmits, to the three-dimensional model designing unit 20, information about the component 42 for which the tolerance entry fields 51 and 52 have been set.

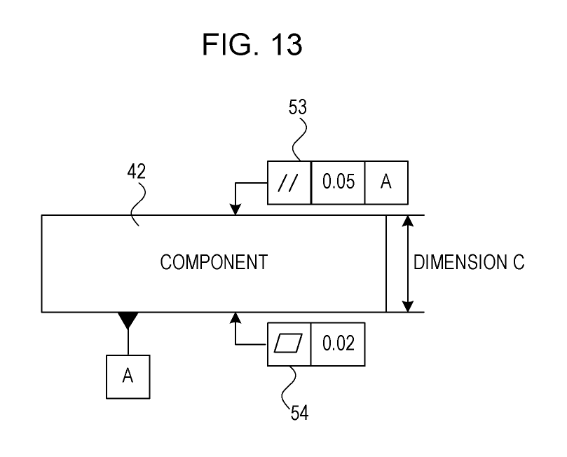

FIG. 13 illustrates an example of a component to which geometrical tolerances are applied.

The designer can set tolerance values in the tolerance entry fields 51 and 52 with reference to a screen displayed by the three-dimensional model designing unit 20 on the monitor 104a.

In FIG. 13, geometrical tolerance information 53 is indicated above the component 42, indicating that the type of geometrical tolerance is parallelism tolerance, the tolerance value is 0.05, and the plane is translational to datum plane A. Geometrical tolerance information 54 is indicated below the component 42, indicating that the type of geometrical tolerance is flatness tolerance and the tolerance value is 0.02.

Next, processing executed by the design assisting apparatus 100 will be described with reference to methods.

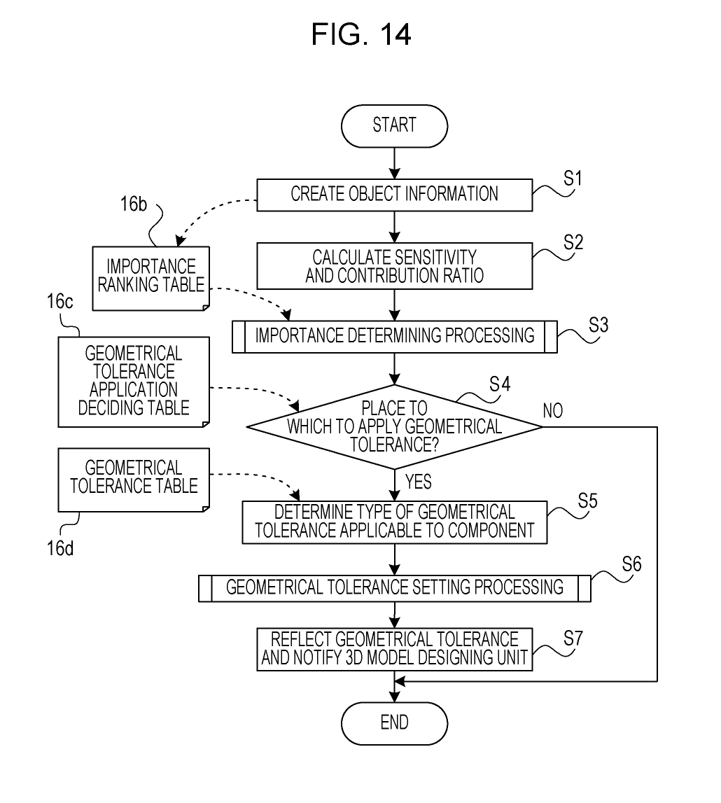

FIG. 14 is a method illustrating whole processing executed by the design assisting apparatus 100.

Step S1: The tolerance analyzing unit 30 executes tolerance analysis to create assembly definition information about components constituting a product to be designed and also create object information in which degrees of freedom are defined between two components. The sequence then proceeds to step S2.

Step S2: The tolerance analyzing unit 30 executes tolerance analysis for the assembly definition information created in step S1 to create the sensitivity of the portion and contribution ratio at the assembly definition place. The sequence then proceeds to step S3.

Step S3: The importance determining unit 11 sets information included in the object information created in step S1 in the importance ranking table 16b. To determine the importance of the portion at each assembly definition place, the importance determining unit 11 uses the information that has been set to execute importance determining processing. The sequence then proceeds to step S4.

Step S4: The geometrical tolerance application determining unit 12 uses the geometrical tolerance application deciding table 16c to decide whether there is a place to which to apply a geometrical tolerance to a dimension of the component. If there is a place to which to apply a geometrical tolerance (the result in step S4 is Yes), the sequence proceeds to step S5. If there is no place to which to apply a geometrical tolerance (the result in step S4 is No), the processing in FIG. 14 is terminated.

Step S5: The geometrical tolerance type determining unit 13 determines a type of geometrical tolerance applicable to the component. The sequence then proceeds to step S6.

Step S6: The reference position determining unit 14 determines the dimension reference position of the component. To set a type of geometrical tolerance, the reference position determining unit 14 uses the determined dimension reference position and the type of tolerance applicable to the component, which has been obtained in step S5, to execute geometrical tolerance setting processing. The sequence then proceeds to step S7. The geometrical tolerance setting processing will be described later in detail.

Step S7: The information adding unit 15 reads the information set in step S6 and enters the read information into the tolerance entry fields 51 and 52. The information adding unit 15 transmits, to the three-dimensional model designing unit 20, information about the component 42 for which the tolerance entry fields 51 and 52 have been set. The processing in FIG. 14 is then terminated.

The illustrated sequence to execute the processing is not a limitation. The processing in step S3 may be executed before step S2, for example.

Next, the processing executed by the tolerance analyzing unit 30 in step S1 will be described with reference to a method.

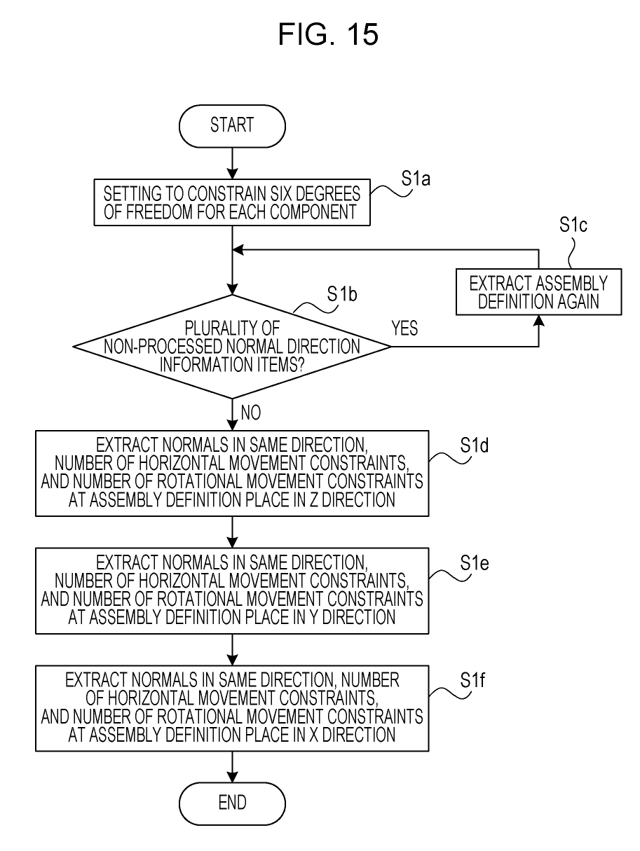

FIG. 15 is a method illustrating processing executed by the tolerance analyzing unit 30.

Step S1a: The tolerance analyzing unit 30 creates information to constrain six degrees of freedom for each component. The sequence then proceeds to step S1b.

Step S1b: The tolerance analyzing unit 30 decides whether there are a plurality of non-processed normal direction information items. If there are a plurality of non-processed normal direction information items (the result in step S1b is Yes), the sequence then proceeds to step S1c.

Step S1c: The tolerance analyzing unit 30 extracts a non-processed assembly definition in a normal direction again. The sequence then returns to step S1b.

Step S1d: The tolerance analyzing unit 30 extracts, from the object information, normal in the same direction, the number of constraints that restrict degrees of freedom in translational movement, and the number of constraints that restrict degrees of freedom in rotational movement, at the assembly definition place in the Z-axis direction. The sequence then proceeds to step S1e.

Step S1e: The tolerance analyzing unit 30 extracts, from the object information, normal in the same direction, the number of constraints that restrict degrees of freedom in translational movement, and the number of constraints that restrict degrees of freedom in rotational movement, at the assembly definition place in the Y-axis direction. The sequence then proceeds to step S1f.

Step S1f: The tolerance analyzing unit 30 extracts, from the object information, normal in the same direction, the number of constraints that restrict degrees of freedom in translational movement, and the number of constraints that restrict degrees of freedom in rotational movement, at the assembly definition place in the X-axis direction. The processing in FIG. 15 is then terminated.

The importance determining processing in step S3 in FIG. 14 will be described with reference to a method.

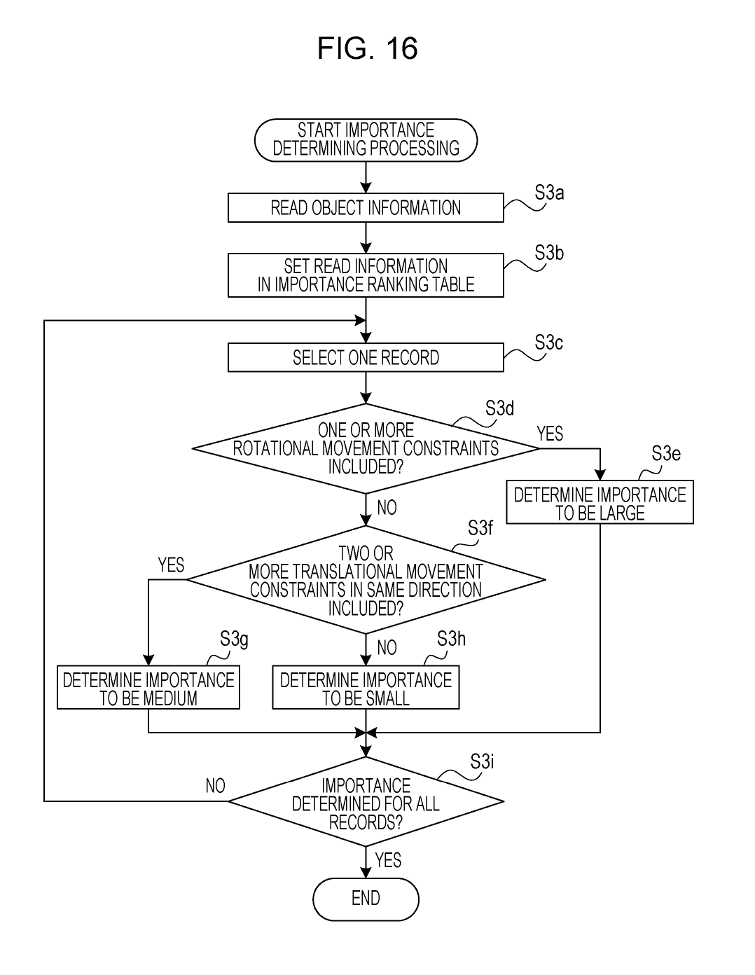

FIG. 16 is a method illustrating importance determining processing.

Step S3a: The importance determining unit 11 reads the number of normal directions and the number of constraints that restrict degrees of freedom from all object information items created in step S1. The sequence then proceeds to step S3b.

Step S3b: The importance determining unit 11 sets the number of normal directions and the number of constraints that restrict degrees of freedom, which have been read in step S3a, in the importance ranking table 16b. The sequence then proceeds to step S3c.

Step S3c: The importance determining unit 11 selects one record from the importance ranking table 16b. The sequence then proceeds to step S3d.

Step S3d: The importance determining unit 11 decides whether the number of rotational movement constraints indicated in the record selected in step S3c is 1 or greater. If the number of rotational movement constraints indicated in the selected record is 1 or greater (the result in step S3d is Yes), the sequence proceeds to step S3e. If the number of rotational movement constraints indicated in the selected record is not 1 or greater (the result in step S3d is No), the sequence proceeds to step S3f.

Step S3e: The importance determining unit 11 determines the importance of the portion at the assembly definition place that is identified by the object information to be large. The sequence then proceeds to step S3i.

Step S3f: The importance determining unit 11 decides whether the number of translational movement constraints indicated in the record selected in step S3c is 2 or greater. If the number of translational movement constraints indicated in the selected record selected is 2 or greater (the result in step S3f is Yes), the sequence proceeds to step S3g. If the number of translational movement constraints indicated in the selected record selected is not 2 or greater (the result in step S3f is No), the sequence proceeds to step S3h.

Step S3g: The importance determining unit 11 determines the importance of the portion at the assembly definition place that is identified by the object information to be medium. The sequence then proceeds to step S3i.

Step S3h: The importance determining unit 11 determines the importance of the portion at the assembly definition place that is identified by the object information to be small. The sequence then proceeds to step S3i.

Step S3i: The importance determining unit 11 decides whether importance has been determined for all records (whether the processing in steps S3d to S3h has been carried out for all records). If the processing in steps S3d to S3h has been carried out for all records (the result in step S3i is Yes), the processing in FIG. 16 is terminated. If the processing in steps S3d to S3h has not been carried out for all records (the result in step S3i is No), the sequence is returned to step S3c, in which the importance determining unit 11 selects one non-processed record and continues to execute the processing in step S3d and later.

Next, the processing executed by the geometrical tolerance application determining unit 12 in step S4 in FIG. 14 will be described with reference to a method.

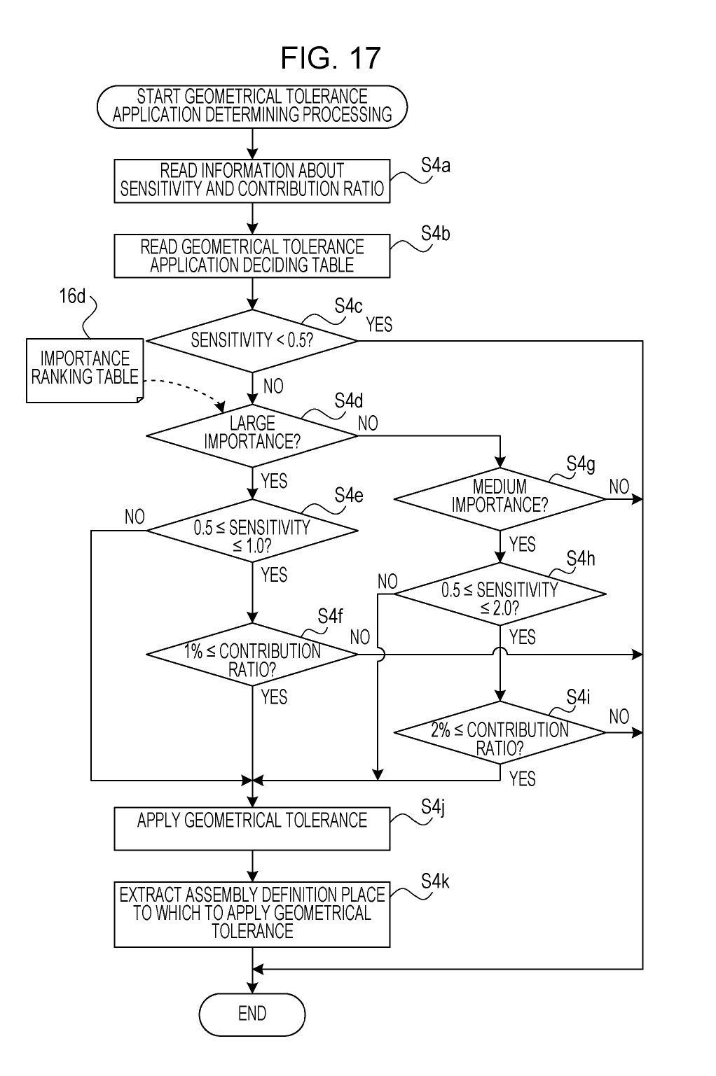

FIG. 17 is a method illustrating geometrical tolerance application determining processing.

Step S4a: The geometrical tolerance application determining unit 12 reads information about the sensitivity and contribution ratio of the portion at the assembly definition place, which is obtained as a result of tolerance analysis calculation carried out by the tolerance analyzing unit 30. The sequence then proceeds to step S4b.

Step S4b: The geometrical tolerance application determining unit 12 reads the geometrical tolerance application deciding table 16c to obtain decision criteria of the sensitivity and contribution ratio used in steps S4c and later. The sequence then proceeds to step S4c.

Step S4c: The geometrical tolerance application determining unit 12 decides whether the sensitivity read in step s4a is smaller than 0.5. If the sensitivity is smaller than 0.5 (the result in step S4c is Yes), the geometrical tolerance application determining processing is terminated. If the sensitivity is 0.5 or greater (the result in step S4c is No), the sequence proceeds to step S4d.

Step S4d: The geometrical tolerance application determining unit 12 decides whether the importance of the assembly definition place is large with reference to the importance ranking table 16b. If the importance of the assembly definition place is large (the result in step S4d is Yes), the sequence proceeds to step S4e. If the importance of the assembly definition place is not large (the result in step S4d is No), the sequence proceeds to step S4g.

Step S4e: The geometrical tolerance application determining unit 12 decides whether the sensitivity of the portion at the assembly definition place is at least 0.5 but smaller than 1. If the sensitivity of the portion at the assembly definition place is at least 0.5 but smaller than 1 (the result in step S4e is Yes), the sequence proceeds to step S4f. If the sensitivity of the portion at the assembly definition place is neither at least 0.5 nor smaller than 1, that is, the sensitivity of the portion at the assembly definition place is 1 or greater (the result in step S4e is No), the sequence proceeds to step S4j.

Step S4f: The geometrical tolerance application determining unit 12 decides whether the contribution ratio of the portion at the assembly definition place is 1% or greater. If the contribution ratio of the portion at the assembly definition place is 1% or greater (the result in step S4f is Yes), the sequence proceeds to step S4j. If the contribution ratio of the portion at the assembly definition place is smaller than 1%, (result in step S4f is No), the geometrical tolerance application determining processing is terminated.

Step S4g: The geometrical tolerance application determining unit 12 decides whether the importance of the assembly definition place is medium. If the importance of the assembly definition place is medium (the result in step S4g is Yes), the sequence proceeds to step S4h. If the importance of the assembly definition place is not medium, that is, the importance of the assembly definition place is small (the result in step S4g is No), the geometrical tolerance application determining processing is terminated.

Step S4h: The geometrical tolerance application determining unit 12 decides whether the sensitivity of the portion at the assembly definition place is at least 0.5 but smaller than 2. If the sensitivity of the portion at the assembly definition place is at least 0.5 but smaller than 2 (the result in step S4h is Yes), the sequence proceeds to step S4i. If the sensitivity of the portion at the assembly definition place is neither at least 0.5 nor smaller than 2, that is, the sensitivity of the portion at the assembly definition place is 2 or greater (the result in step S4h is No), the sequence proceeds to step S4j.

Step S4i: The geometrical tolerance application determining unit 12 decides whether the contribution ratio of the portion at the assembly definition place is 2% or greater. If the contribution ratio of the portion at the assembly definition place is 2% or greater (the result in step S4i is Yes), the sequence proceeds to step S4j. If the contribution ratio of the portion at the assembly definition place is smaller than 2%, (result in step S4i is No), the geometrical tolerance application determining processing is terminated.

Step S4j: The geometrical tolerance application determining unit 12 determines that a geometrical tolerance is to be applied to the assembly definition place. The sequence then proceeds to step S4k.

Step S4k: The geometrical tolerance application determining unit 12 sets tolerance entry fields for the dimension of the assembly definition place for which the geometrical tolerance application determining unit 12 has determined to apply a geometrical tolerance. The processing in FIG. 17 is then terminated.

Next, the geometrical tolerance setting processing in step S6 in FIG. 14 will be described.

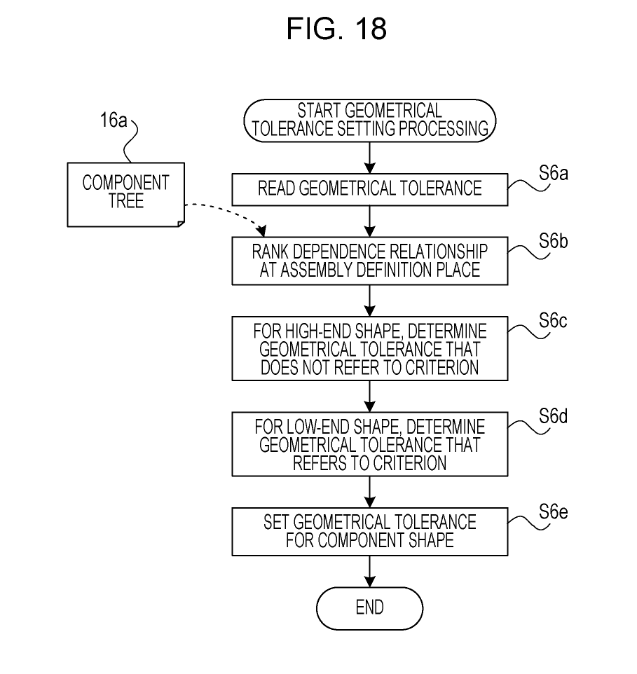

FIG. 18 is a method illustrating geometrical tolerance setting processing.

Step S6a: The reference position determining unit 14 reads the type of geometrical tolerance, which has been extracted by the geometrical tolerance type determining unit 13 in step S6. The sequence then proceeds to step S6b.

Step S6b: The reference position determining unit 14 ranks the dependence relationship of the assembly definition place with reference to the component tree 16a. The sequence then proceeds to step S6c.

Step S6c: The reference position determining unit 14 determines that a geometrical tolerance that does not refer to a criterion is to be applied to a shape ranked at a high-end. The sequence then proceeds to step S6d.

Step S6d: The reference position determining unit 14 determines that a geometrical tolerance that refers to a criterion is to be applied to a shape ranked at a low-end. The sequence then proceeds to step S6e.

Step S6e: The reference position determining unit 14 sets a geometrical tolerance for the component shape. The geometrical tolerance setting processing is terminated.

As described above, the geometrical tolerance application determining unit 12 of the design assisting apparatus 100 can use the geometrical tolerance application deciding table 16c to decide whether to apply a geometrical tolerance to a place. Thus, it is possible to suppress a place to which to apply a geometrical tolerance from being overlooked, enabling design quality to be improved.

### Application Example

The design assisting apparatus 100 may make an assembly definition in a direction that is neither perpendicular nor horizontal in an absolute coordinate system in three-dimensional CAD. How normal direction information is handled in this case will be described below.

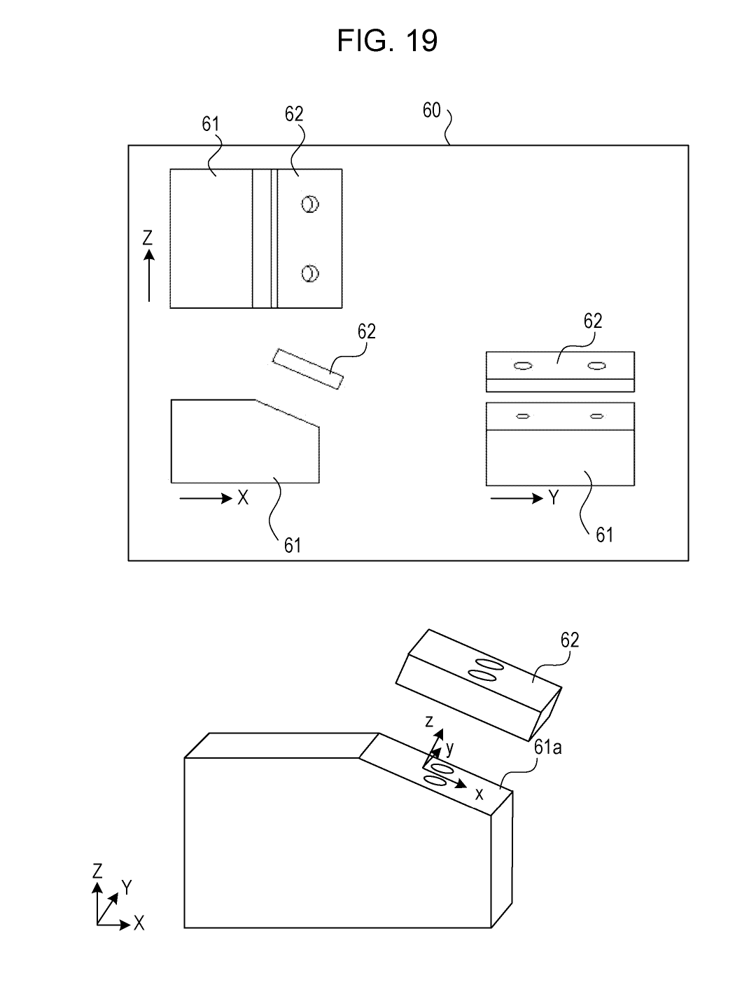

FIG. 19 illustrates an application example.

When an assembly definition is made in a direction that is neither perpendicular nor horizontal in an absolute coordinate system in three-dimensional CAD, a normal direction between mating plates in the assembly definition is used as normal direction information.

The three-view drawing 60 in FIG. 19 indicates a base 61 and a plate 62 as viewed from the X-axis direction, Y-axis direction, and Z-axis direction in an absolute coordinate system in three-dimensional CAD.

When an assembly definition is made so that the plate 62 is assembled to an oblique line 61a of the base 61 in a face-to-face manner, a match with absolute coordinates in three-dimensional CAD is not obtained. Accordingly, normal direction coordinates x, y, and z in the normal directions of the assembled plane are defined. The normal directions of the plane are used as normal direction information.

### Third Embodiment

A third embodiment differs from the second embodiment in a three-dimensional model to be designed.

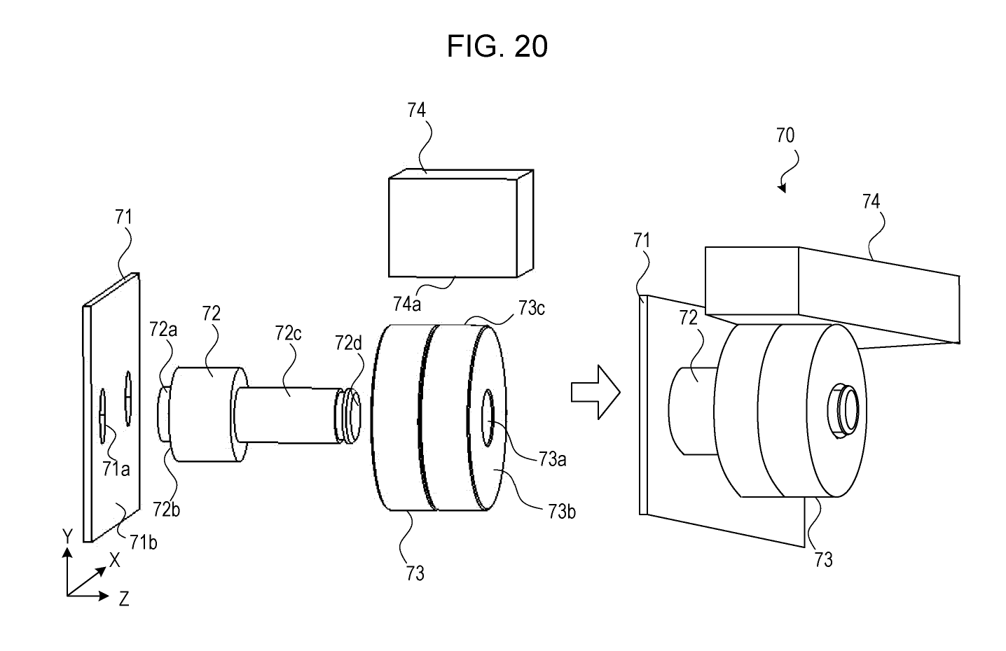

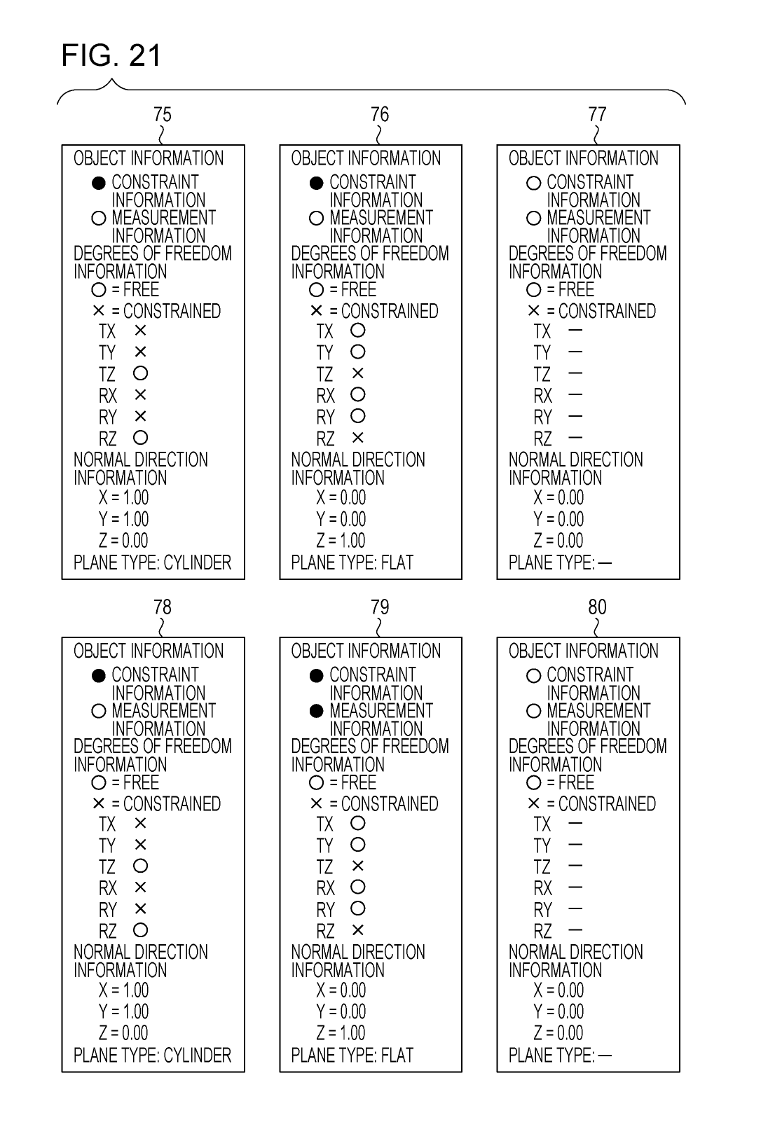

FIG. 20 illustrates an example of a three-dimensional model in the third embodiment. FIG. 21 illustrates object information items at assembly definition places in the third embodiment.

The three-dimensional model 70 in the third embodiment, illustrated in FIG. 20, has a plate 71, which is rectangular, an axis 72, a roller 73, and a block 74. The directions along the rectangle of the plate 71 are references in the X-axis direction and Y-axis direction.

The three-dimensional model 70 has four assembly definition places, a fifth assembly definition place to an eighth assembly definition place. The fifth and sixth assembly definition places relate to an assembly of the plate 71 and axis 72, and the seventh and eighth assembly definition places relate to an assembly of the axis 72 and roller 73.

The fifth assembly definition place indicates a place at which a cylindrical plane 72a of the axis 72 and holes 71a made in the plate 71, the normal direction of which is the Z-axis direction, are assembled together. The number of normal in the same direction is 2, the number of constraints that restrict translational movement is 2, and the number of constraints that restrict rotational movement is 2.

The object information 75 in FIG. 21, which relates to the fifth assembly definition place, indicates that the X-axis direction and Y-axis direction are perpendicular directions and that TX, TY, RX, and RY are constrained. The object information 75 also indicates that there is no other assembly definition place having information about normal directions in the X-axis and Y-axis directions. Since the object information 75 still includes degrees of freedom in the free state (TZ and RZ), the tolerance analyzing unit 30 makes an assembly definition relating to other normal directions of the plate 71 and axis 72.

The sixth assembly definition place indicates a place at which a flat plane 72b of the axis 72 and a flat plane 71b of the plate 71, the normal direction of which is the Y-axis direction, are assembled together. The number of normal in the same direction is 1, the number of constraints that restrict translational movement is 1, and the number of constraints that restrict rotational movement is 1.

The object information 76 in FIG. 21, which relates to the sixth assembly definition place, indicates that the Z-axis direction is a perpendicular direction and that TZ and RZ are constrained. The object information 76 also indicates that there is no other assembly definition place having information about the normal direction in the Z-axis direction. All the six degrees of freedom are constrained by the object information 75 and object information 76. Accordingly, an assembly definition relating to the normal directions in the X-axis direction of the plate 71 and axis 72 is not made. However, the tolerance analyzing unit 30 creates the object information 77 in FIG. 21 in which the X-axis direction is used as the normal direction. Since all the six degrees of freedom can be constrained by the object information 75 and object information 76, all relevant fields in the object information 77 are blank.

The seventh assembly definition place indicates a place at which a hole 73a made in the roller 73 and a cylindrical plane 72c of the axis 72, the normal direction of which is the X-axis direction, are assembled together. The number of normal in the same direction is 1, the number of constraints that restrict translational movement is 2, and the number of constraints that restrict rotational movement is 2.

The object information 78 in FIG. 21, which relates to the seventh assembly definition place, indicates that the X-axis direction and Y-axis direction are perpendicular directions and that TX, TY, RX, and RY are constrained. The object information 78 also indicates that there is no other assembly definition place having information about normal directions in the X-axis and Y-axis directions. Since the object information 78 still includes degrees of freedom in the free state (TZ and RZ), the tolerance analyzing unit 30 makes an assembly definition relating to other normal directions of the plate 71 and axis 72.

The eighth assembly definition place indicates a place at which a side plane 73b of the roller 73 and the flat plane 72d of the axis 72, the normal direction of which is the Y-axis direction, are assembled together. The number of normal in the same direction is 1, the number of constraints that restrict translational movement is 1, and the number of constraints that restrict rotational movement is 1.

The object information 79 in FIG. 21, which relates to the eighth assembly definition place, indicates that the Z-axis direction is a perpendicular direction and that TZ and RZ are constrained. The object information 79 also indicates that there is no other assembly definition place having information about the normal direction in the Z-axis direction. All the six degrees of freedom are constrained by the object information 78 and object information 79. Accordingly, an assembly definition relating to the normal directions in the Z-axis direction of the axis 72 and roller 73 is not made. However, the tolerance analyzing unit 30 creates the object information 80 in FIG. 21 in which the Z-axis direction is used as the normal direction. Since all the six degrees of freedom can be constrained by the object information 78 and object information 79, all relevant fields in the object information 80 are blank.

The tolerance analyzing unit 30 also defines a target to be measured between a cylindrical plane 73c of the roller 73 and a flat plane 74a of the block 74. If a target to be measured is defined, the geometrical tolerance type determining unit 13 unconditionally determines that a geometrical tolerance is to be applied.

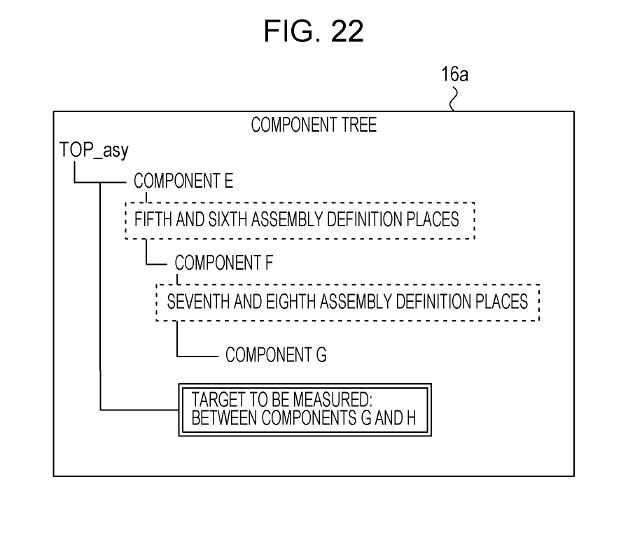

FIG. 22 illustrates a component tree in the third embodiment.

In the component tree 16a in the third embodiment, the plate 71 is represented as a component E, the axis 72 is represented as a component F, the roller 73 is represented as a component G, and the block 74 is represented as a component H.

The component tree 16a in the third embodiment indicates that there are two assembly definitions, which are identified by the fifth and sixth assembly definition places, between the plate 71 and the axis 72 and that there are two assembly definitions, which are identified by the seventh and eighth assembly definition places, between the axis 72 and the roller 73. The component tree 16a also indicates that the axis 72 is subordinate to the plate 71 and the roller 73 is subordinate to the axis 72. The component tree 16a also indicates that when the three-dimensional model 70 is created, the plate 71 is assembled to the axis 72, after which the roller 73 is assembled. The component tree 16a also indicates that a target to be measured is defined between the roller 73 and the block 74.

Next, the importance determining unit 11 references the importance ranking table 16b stored in the storage unit 16 and uses the number of normal directions and the number of constraints that restrict degrees of freedom, which have been extracted by the tolerance analyzing unit 30 to determine importance of the portion at each assembly definition place. At the fifth assembly definition place, at least one of RX, RY, and RZ is constrained, so the importance determining unit 11 determines the importance of the portion at the fifth assembly definition place to be large. At the sixth assembly definition place, at least two of TX, TY, and TZ are constrained in the same direction, so the importance determining unit 11 determines the importance of the portion at the sixth assembly definition place to be medium. At the seventh assembly definition place, at least one of RX, RY, and RZ is constrained, so the importance determining unit 11 determines the importance of the portion at the seventh assembly definition place to be large. At the eighth assembly definition place, at least two of TX, TY, and TZ are constrained in the same direction, so the importance determining unit 11 determines the importance of the portion at the eighth assembly definition place to be medium.

The geometrical tolerance application determining unit 12 determines whether to apply a geometrical tolerance to each portion at the fifth to eighth assembly definition places at which importance has been ranked.

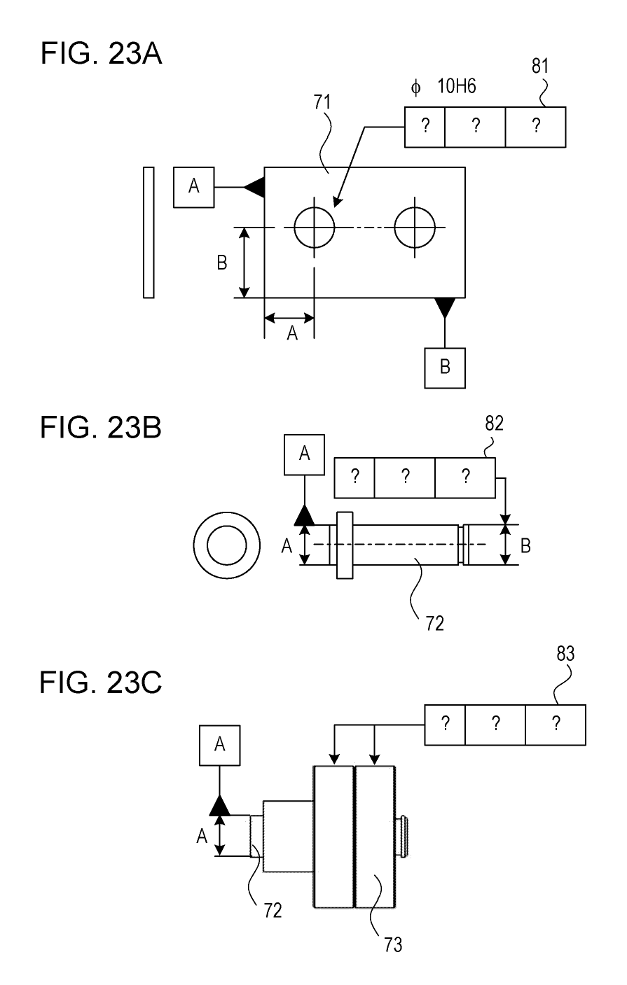

FIGS. 23A to 23C illustrate processing results obtained from the geometrical tolerance application determining unit 12 in the third embodiment.

FIG. 23A is a drawing of the plate 71. A tolerance entry field 81 is set for dimensions A and B for which application of a geometrical tolerance has been determined. FIG. 23B is a drawing of the axis 72. A tolerance entry field 82 is set for a dimension B for which application of a geometrical tolerance has been determined. FIG. 23C is a drawing of an assembly of the axis 72 and roller 73. A tolerance entry field 83 is set for a dimension of the roller 73 for which application of a geometrical tolerance has been determined.

When the geometrical tolerance setting unit 10 performs subsequent processing as in the second embodiment, the three-dimensional model designing unit 20 can display the three-dimensional model 70 to which geometrical tolerance information has been given on the monitor 104a.

Although so far, the design assisting apparatus in the present disclosure has been described according to the embodiments in the drawings, this is not a limitation to the present disclosure; the structure of each unit may be replaced with a structure having similar functions. Any other structural members and processes may be added to the present disclosure.

In the present disclosure, any two or more structures (features) in each embodiment described above may be combined.

Processing carried out by the design assisting apparatus 100 may be carried out by a plurality of apparatus in a distributed manner. For example, one apparatus may perform tolerance analysis to create object information and a component tree, and another apparatus may use the object information and component tree to determine a place to which to apply a geometrical tolerance.

The processing functions described above can be implemented by a computer. In this case, a program in which processing executed by functions of the design assisting apparatus 1 or 100 is coded is provided. When a computer executes the program, the processing functions are implemented on the computer. The program, in which processing is coded, can be recorded on a computer-readable medium in advance. Computer-readable media include media in magnetic storage devices, optical disks, magneto-optical storage media, and semiconductor memories. Medium in magnetic storage devices include media in hard disk drives, flexible disks (FDs), and magnetic tapes. Optical disks include DVDs, DVD-RAMS, CD-ROMs, and CD-RWs. Magneto-optical storage media include magneto-optical disks (MOs).

To place the program on the market, a DVD, CD-ROM, or another type of transportable recording medium on which the program has been recorded is sold. It is also possible to store the program in a storage unit of a server computer and transfer the program from the server computer to another computer through a network.

The program recorded on the transportable recording medium or transferred from the server computer is supplied to a computer intended to execute the program. The computer stores the supplied program in its storage unit, for example. The computer reads the program from the storage unit and executes processing according to the program. The computer can also read the program directly from the transportable storage medium and can execute processing according to the program. The computer can also execute processing according to the program each time the computer receives the program from the server computer connected through the network.

At least part of the above processing functions can also be implemented by a digital signal processor (DSP), an application-specific integrated circuit (ASIC), a programmable logic device (PLD), or another electronic circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A design assisting apparatus, comprising:
a processor; and
a memory coupled to the processor, wherein the processor executes a process includes:
storing a number of restrictions that restrict degrees of freedom in a translational direction and a rotational direction of each of three dimensional directions at an assembled place in an assembled state of a component that is part of a product to be designed; and
deciding, by using the number of the restrictions stored in the storing, whether or not to apply a geometrical tolerance to the dimension at the assembled place of the component.

2. The design assisting apparatus according to claim 1,
wherein the deciding further decides, by using sensitivity of the component that is obtained through tolerance analysis carried out for the component, whether or not to apply a geometrical tolerance to the dimension at the assembled place of the component.

3. The design assisting apparatus according to claim 2,
wherein the deciding further decides, by using a contribution ratio of the component, which is obtained through tolerance analysis carried out for the component, whether or not to apply a geometrical tolerance to the dimension at the assembled place of the component.

4. The design assisting apparatus according to claim 1, the process further comprising:
pre-storing types of geometrical tolerances; and
deciding, by using the types of geometrical tolerances pre-stored and information about a portion at the assembled place, a type of tolerance applicable to the component.

5. The design assisting apparatus according to claim 4, the process further comprising:
deciding, by using information indicating a positional relationship between components, a dimension reference position of a component; and
deciding, by using the determined dimension reference position, a type of geometrical tolerance to be applied to the component.

6. A method for assisting design by using a computer, the method comprising:
storing a number of restrictions that restrict degrees of freedom in a translational direction and a rotational direction of each of three dimensional directions at an assembled place in an assembled state of a component that is part of a product to be designed; and
deciding, by using the number of the restrictions stored in the storing, whether or not to apply a geometrical tolerance to the dimension at the assembled place of the component.

7. A computer-readable recording medium having stored therein a program for causing a computer to execute a process for assisting design, the process comprising:
storing a number of restrictions that restrict degrees of freedom in a translational direction and a rotational direction of each of three dimensional directions at an assembled place in an assembled state of a component that is part of a product to be designed; and
deciding, by using the number of the restrictions stored in the storing, whether or not to apply a geometrical tolerance to the dimension at the assembled place of the component.
